(19) United States
(12) Patent Application Publication
(10) Pub. No.: US 2009/0293474 A1
(43) Pub. Date: Dec. 3, 2009

(54) Turbine driven accessories

(76) Inventor: George Campbell Lucia, De Pere, WI (US)

Correspondence Address: GEORGE C. LUCIA, 214 N. SUPERIOR STREET, DE PERE, WI, 54115, US

(21) Appl. No.: 11/600,956

(22) Filed: Nov. 17, 2006

Related U.S. Application Data
(60) Provisional application No. 60/751,483, filed on Dec. 19, 2005.

(51) Int. Cl. F02B 65/00

(52) U.S. Cl. 60/597

(57) ABSTRACT

A vehicle design utilizing a turbine driven by the exhaust from the vehicle internal combustion engine is disclosed. With this design, one or more of the car accessories are directly driven by one or more turbines powered by the internal combustion engine through one or more common mechanical linkages. The linkages may be a belt, shaft or other mechanical means. The accessories may include any or all of the following: the alternator that generates electricity for the vehicle electrical system, the air conditioning compressor, the power steering pump, the water pump, the oil pump, the hydraulic pump, the radiator fan, and the air pump for the exhaust emissions system. A compressor for boosting intake air flow may also be included with the accessories.

### RELATED APPLICATIONS

This application claims priority from Provisional Patent Application No. 60/751,483 filed on Dec. 19, 2005.

### BACKGROUND OF THE INVENTION

1. Field of the Invention

This invention pertains to vehicles utilizing a turbine driven by the exhaust from an internal combustion engine for high power performance. Vehicles utilizing a turbine include standard gasoline vehicles, diesel vehicles and hybrid electric vehicles.

2. Description of Prior Art

In a conventional internal combustion engine vehicle utilizing a turbine, the internal combustion engine drives a turbine where fuel is continuously burnt with compressed air to produce a stream of hot, fast moving gas. This gas stream is used to power a compressor that supplies the air to the engine as well as provide excess energy that may be used to do other work. A typical configuration for a conventional engine that drives a turbine and compressor system is shown in FIG. 1. In the current art, compressed air and fuel are fed through the intake manifold into the internal combustion engine. The fuel may be gasoline, diesel, ethanol or ethanol blends. The fuel is combusted in the engine and exhaust air produced from the combustion of the fuel exits through an exhaust manifold and runs a turbine which extracts energy form the gases. The turbine drives a compressor that compresses air fed back into the engine. The excess gases from the turbine are exhausted through the automobile exhaust system.

U.S. Pat. No. 5,857,336 describes a power plant system particularly useful for hybrid vehicles driven by electric motors, the power plant system including a positive displacement engine with a bifurcated exhaust forming first and second exhaust passages for expansion gases, each passage being separately controlled by an independently operated engine exhaust valve, the first exhaust passage supplying expansion gases to a turbine connected to a compressor delivering compressed air to the engine and the second exhaust passage supplying expansion gases to a turbine connected to an electric generator, the power plant system having a system control module independently controlling each exhaust valve for optimum air compression for the load and speed of engine operation.

U.S. Pat. No. 6,546,736 teaches a method of operating a gas turbine engine comprising a power turbine mounted downstream a compressor, and a compressor turbine mounted downstream the power turbine for rotation in a direction opposite to the rotation direction of the power turbine. Exhaust fluid from the compressor turbine is cooled in a heat exchanger with a compressed fluid downstream the compressor and is then cooled with air in separate heat exchanger before being admitted to the compressor. A part of the compressed fluid heated in the heat exchanger is fed to cool the turbine blades, and the rest of the fluid is fed to a heated fluid source for the turbine.

U.S. Pat. No. 6,931,850 is directed to a hybrid electric vehicle that includes an internal combustion engine, an electric motor and a transmission. A turbocharger is in fluid communication with the internal combustion engine. Moreover, a generator is mechanically coupled to the turbocharger and thereby driven by exhaust gas from the internal combustion engine. The generator can provide electricity to the motor and/or a battery while simultaneously providing altitude compensation for the internal combustion engine so that the internal combustion engine output remains at the same power and efficiency as altitude and environmental conditions change. The turbocharger can also be used for power boost if desired. The exhaust gas driven generator system can be deployed in conventional vehicles as well to charge the battery and/or power electrical accessories, thereby replacing the alternator.

Also in the current art, the engine crank shaft is generally configured to drive the transmission and the alternator or generator through a mechanical linkage such as a belt. In turn, the alternator powers the battery which in turn powers the vehicle accessories including air conditioner, the power steering pump, the water pump, the oil pump, the hydraulic pump, the radiator fan and the air pump for the exhaust system. The main disadvantage of this configuration is the loss of power incurred from running the accessories. The Society of Automotive Engineers estimates that about 20% of the engine power is used for driving the vehicle accessories.

Prior art disclosures of turbines directly driving a generator or an alternator through a mechanical linkage appear in several references.

U.S. Pat. No. 6,470,680 discloses a manifold alternator generator that includes a turbine located proximal to a flow of exhaust gases in an internal combustion engine where the exhaust gases energize the turbine and produce rotation of an output shaft. The output shaft is connected to a rotor that is engaged with a generator such that the rotation of the turbine and output shaft generates electrical power.

Jefferson discloses in U.S. Pat. No. 6,800,951 heat energy converting the liquid fluid into a super heated high pressure energy vapor. This super heated pressure energy is then transformed into mechanical energy by means of a rotary turbine. The turbines' mechanical energy is used to turn the generator or alternator producing an electric energy source. The electric energy at this point will have means for stepping up the voltage to a higher output of electric energy needed for operating other electrical and/or electronic devices and applications apart from the system. Part of the higher electric energy output is also directed back into the system where the lower amount of electric energy is needed to cause the heat energy.

U.S. Pat. No. 7,047,743 makes reference to an engine/electric generator system that includes an internal combustion engine, a primary electric generator driven by an output shaft of the engine and providing electrical power. A turbocharger has a first turbine driven by exhaust gasses from the engine and a compressor driven by the first turbine and provides inlet air to the engine. The system also includes a secondary turbine, and an exhaust line which communicates exhaust gas from the first turbine to an input of the secondary turbine. A secondary electric generator is driven by the secondary turbine. An electric power combining circuit combines electric power from the primary electric generator and the secondary electric generator, and delivers combined electric power to a transmission line.

Pre-grant publication No 20040090204 teaches a permanent magnet generator that generates a variable voltage/variable frequency electric current to power electric induction motors. These motors, in turn, may be used to power electric motor driven engine accessories. The permanent magnet generator is powered directly by a gas turbine engine. A ratio of the variable voltage to the variable frequency remains substantially constant throughout all operating conditions of the gas turbine engine. The relationship of engine speed to accessory speed will remain fixed as the engine speed varies, similarly to the relationship realized when a gearbox was employed. The resulting power system is useful in supplying power from a gas turbine engine to various induction motor driven accessories in aircraft, ground based vehicles, and the like, particularly when the engine has no gearbox. The power system requires no motor controllers and may be. used to supply any induction motor driven equipment, including equipment which is not traditionally engine or gearbox mounted.

Pre-grant publication No 20050050887 is directed to a hybrid electric vehicle that includes an internal combustion engine, an electric motor and a transmission. A turbocharger is in fluid communication with the internal combustion engine. Moreover, a generator is mechanically coupled to the turbocharger and thereby driven by exhaust gas from the internal combustion engine. The generator can provide electricity to the motor and/or a battery while simultaneously providing altitude compensation for the internal combustion engine so that the internal combustion engine output remains at the same power and efficiency as altitude and environmental conditions change. The turbocharger can also be used for power boost if desired. The exhaust gas driven generator system can be deployed in conventional vehicles as well to charge the battery and/or power electrical accessories, thereby replacing the alternator.

Pre-grant publication No 20060120702 offers a new approach to steam generation, in that it will create steam in a dry chamber or cell, where there is no water level as with the common steam boiler. The steam cell only heats a small spray of water that is injected over super heated coils surrounding an inverted high conductive metal canister. The coils can be heated with battery power using DC, or AC current. The canister can also be heated with an alternative application that is actually on the exterior of the enclosure and heats the inside of the inverted canister using fuel such as propane or alcohol. The purpose is to create a steady supply of steam to power a turbine that will drive an alternator or generator and create electricity that will heat the coils, and in turn charge a battery and supply additional power for applications such as an automobile or any other application where electric power, pressure or steam heat can be used. The goal is to create an automobile such as the gas/electric hybrid using the steam cell in conjunction with the turbine to replace the gasoline engine.

### THE PRESENT INVENTION

In the present invention, one or more of the car accessories are directly driven by one or more turbines powered by the internal combustion engine through one or more common mechanical linkages. The linkages may be a belt, shaft or other mechanical means. The accessories may include any or all of the following: the alternator that generates electricity for the vehicle electrical system, the air conditioning compressor, the power steering pump, the water pump, the oil pump, the hydraulic pump, the radiator fan, and the air pump for the exhaust emissions system. A compressor for boosting intake air flow may or may not be included with the accessories.

In one embodiment of the invention, all of the accessories are driven through a belt linkage. In another embodiment, any four of the accessories are driven by one turbine through a belt linkage, while the remainder accessories are driven by a second turbine using a belt, shaft, or other mechanical means. Other similar combinations of some accessories being driven by one turbine with the remainder accessories being driven by another turbine are within the scope of this invention.

The use of a turbine for driving the accessories is expected to improve the fuel economy by 10-20% as data show that about 20% of the engine power is pulled by the accessories. The fuels that can be used in the internal combustion engine include gasoline, diesel, ethanol, and liquid petroleum. This invention applies to internal combustion engines that may be powered by gasoline, ethanol or diesel fuels, and used for driving conventional gasoline, diesel or hybrid vehicles. The types of vehicles that may use this invention include passenger cars, trucks, farm tractors, road graders, off highway heavy equipment, Wenkel engines, boats, and stationary power units. The benefit of this invention comes from the utilization of the exhaust gases exiting the engine for driving the turbine rather than allowing these gases to exhaust out of the vehicle. This in turn is used to produce power for driving the vehicle accessories. The benefits of this invention include better fuel economy, fewer emissions, and the reduction in the size of the engine to perform the designed functions.

### BRIEF DESCRIPTION OF THE DRAWINGS

FIG. 1 shows the conventional turbine engine configuration.

FIG. 2 is a depiction of a mechanical drive linkage for the alternator powered by the turbine as disclosed in prior art references.

FIG. 3 is a sketch of a belt drive system for the accessories driven by the turbine.

FIG. 4 is a schematic of a shaft arrangement used for driving a multitude of vehicle accessories by the turbine.

### DETAILED DESCRIPTION OF THE DRAWINGS

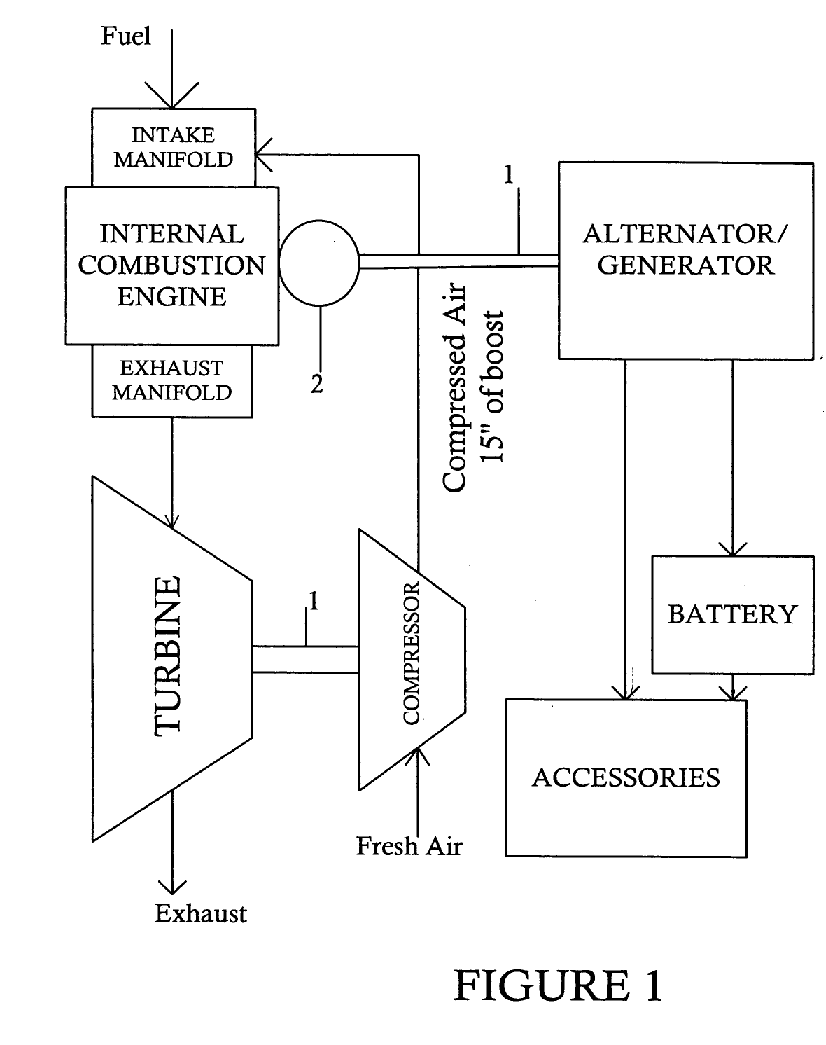

FIG. 1 shows the conventional turbine engine configuration. Fuel is fed into the intake manifold of the engine which in turn feeds the internal combustion engine. The exhaust drives a turbine which drives a compressor through a mechanical linkage (1). The compressor feeds compressed air into the engine through the intake manifold. The crank shaft (2) drives the alternator or generator by a mechanical linkage (1), which in turn supplies electrical power to the battery and the accessories.

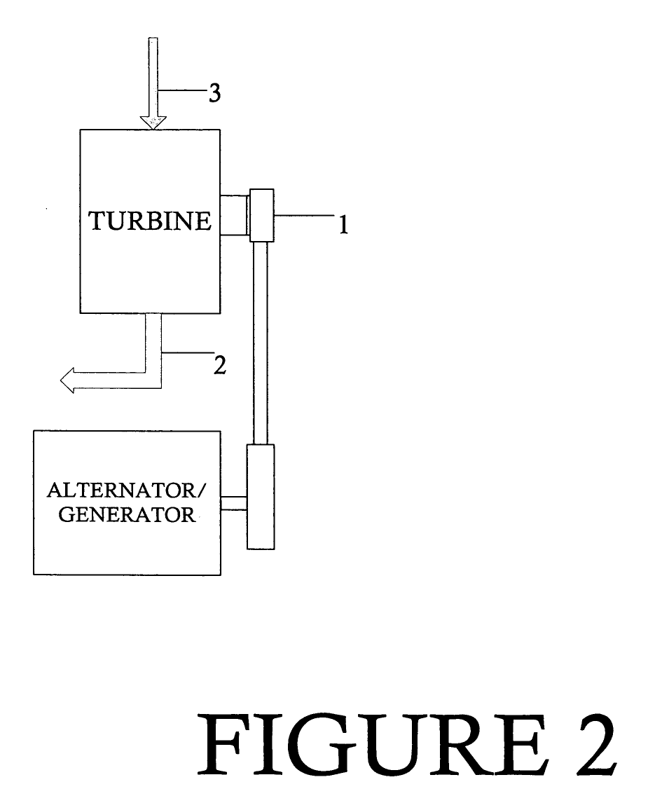

FIG. 2 shows the turbine driving the alternator or generator through a mechanical linkage (1). The turbine is powered by gases (3) exhausted from the engine. Exhaust gases (2) exit the turbine.

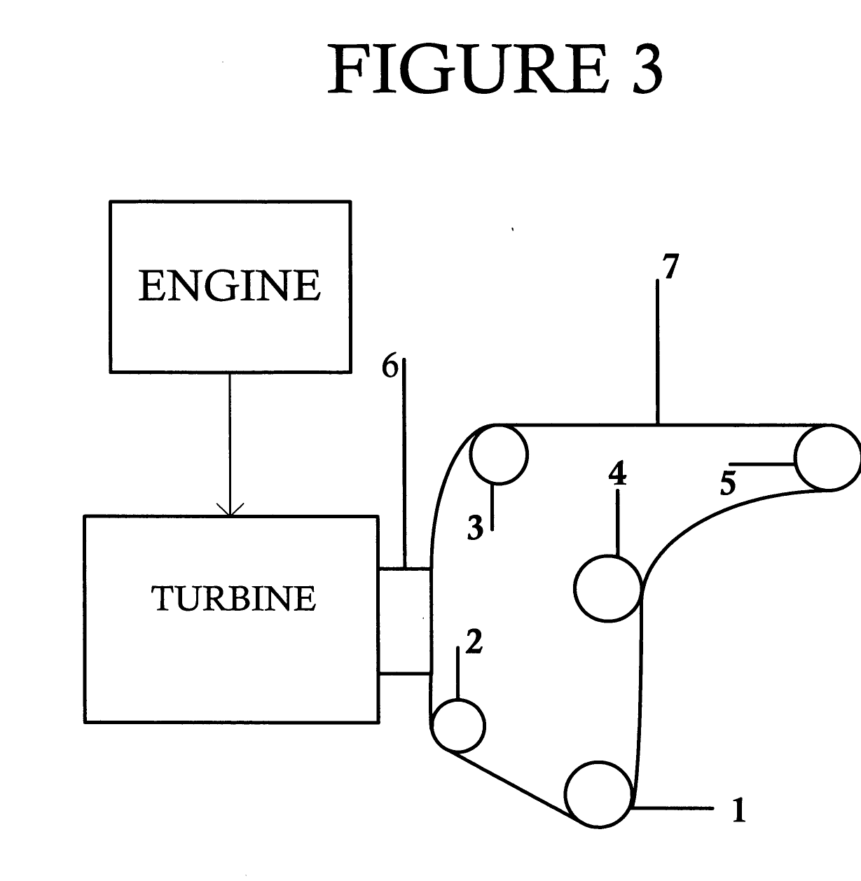

FIG. 3 depicts the vehicle engine driving a turbine by means of exhaust gases. The turbine drives a belt by means of mechanical linkage (6). The belt drives accessories (1), (2), (3), (4), (5), and (7). The accessories may be any listed above.

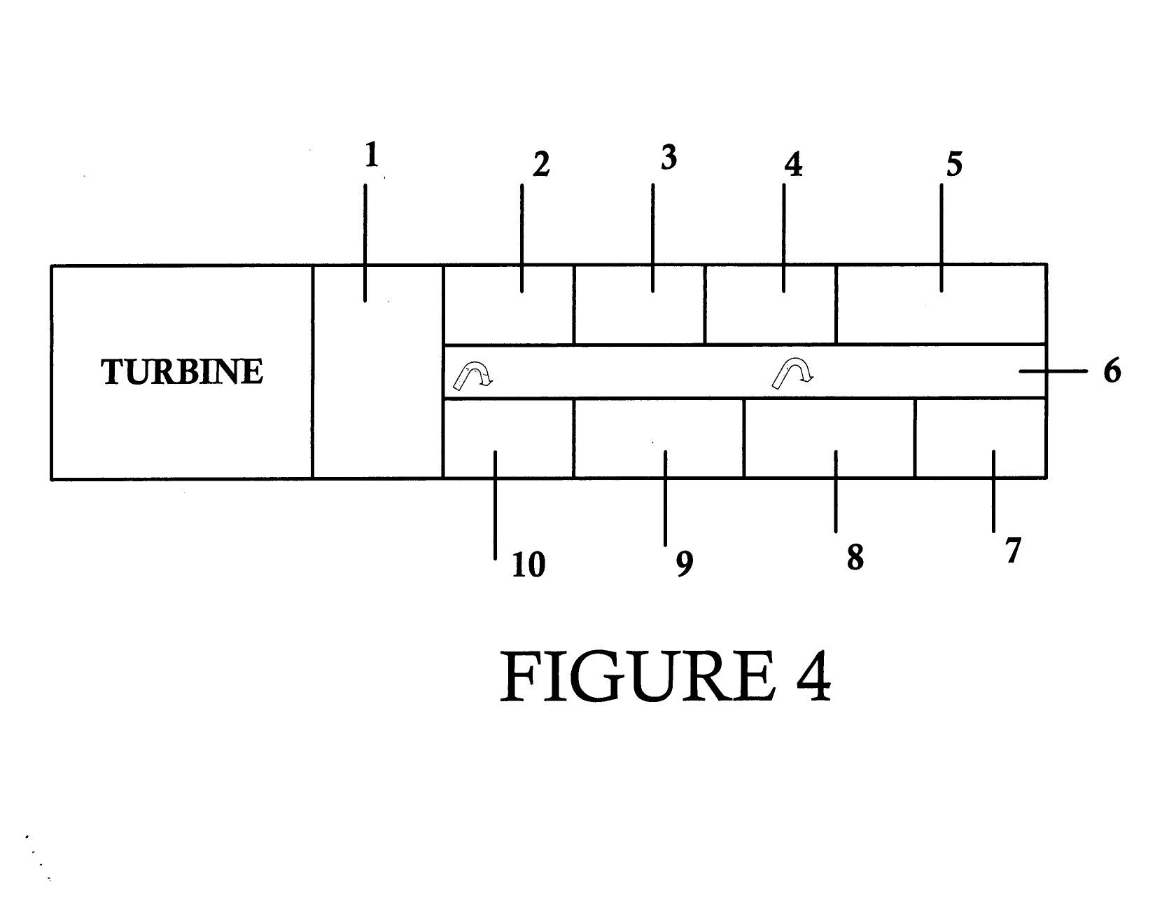

FIG. 4 shows a turbine driving a shaft (6) by mechanical linkage (1) accessories (2), (3), (4), (5), (7) (8), (9), and (10). The accessories may be any listed above.

1. A system for driving vehicle accessories comprising of:
an internal combustion engine
at least one turbine driven by said engine exhaust gases
a drive system connecting the turbine to at least one vehicle accessory by a mechanical linkage.

2. The system of claim 1, wherein the internal combustion engine powers a hybrid vehicle.

3. The system of claim 1, wherein the internal combustion engine is a diesel engine.

4. The system of claim 1, wherein the internal combustion engine is a standard gasoline engine.

5. The system of claim 1 wherein said mechanical linkage comprises a belt.

6. The system of claim 1 wherein said mechanical linkage comprises a shaft.

7. The system of claim 1, wherein the turbine is connected to at least nine accessories.

8. The system of claim 1, comprising of two turbines.

9. The system of claim 7 wherein said accessories include the alternator, the radiator fan, compressor, the air conditioner, the power steering pump, the water pump, the oil pump, the hydraulic pump, and the air pump for the exhaust system.

10. The system of any of claims 8 or 9, wherein any four of the accessories are driven by one turbine and the remaining accessories are driven by the other turbine.
